(19) United States
(12) Patent Application Publication
(10) Pub. No.: US 2009/0327231 A1
(43) Pub. Date: Dec. 31, 2009

(54) INLINE ENHANCEMENT OF WEB LISTS

(75) Inventors: Eric Zappa, Seattle, WA (US); Abdul Haadi Mohammed, Redmond, WA (US); Dipinder Sing Rekhi, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/147,630

(22) Filed: Jun. 27, 2008

(51) Int. Cl. G06F 17/30

(52) U.S. Cl. 707/3; 707/E17.014

(57) ABSTRACT

Method of searching for one or more images that relate to a list entry item on a web based list. In one implementation, the method may include receiving a request to search for the one or more images that relate to the list entry, sending the request to an online server, receiving a file containing one or more search results having one or more URL addresses indicating one or more locations of the one or more images on the online server and information pertaining to the one or more images and displaying the one or more images.

### BACKGROUND

Social networking websites provide its users the ability to share their unique taste in specific genres to an online community in the form of lists. These lists typically reflect the user's favorite items in categories, such as books, movies, music, and the like. Recently, users have expressed a desire to enhance their list entry items by displaying relating images next to their list entry items.

Searching for an image and information pertaining to the list entry items may cause the user to open additional browsers, perform manual searches on various websites, and transfer all of the information that he has located back into the web page displaying his list entry item. These tedious methods for enhancing list entries may lead to an inefficient use of the user's time or the abandonment of enhancing lists altogether.

### SUMMARY

Described herein are implementations of various technologies for enhancing a list entry item on a web-based list by adding a thumbnail image related to the list entry item while displayed on the web-based list. When adding a list entry item to the web-based list, a user may submit a request on a webpage to search for an image to add as a thumbnail image next to the entry item. In one implementation, a user may use an internet browser to access a client-side list application on an online server to search another online server containing a database of image files for an image matching the list entry item. In order to search for images matching the list entry item, the client-side list application may request the user to input data into information fields specifically pertaining to the online list's genre.

After receiving the input data from the user, the client-side list application may send this data to a server-side list application which may be stored on the online server containing the database of image files. The server-side list application may use the data provided to search the database of image files for matching image files that may be used to enhance the list entry.

Using a searching algorithm, the server-side list application may locate a number of image files that contain data matching the data input by the user into the information fields provided by the client-side list application. The server-side list application may package all or some of the matching image files together into a single computer file, and it may then send the file back to the client-side list application.

Upon receiving the computer file, the client-side list application may convert the computer file into a medium that the user's internet browser may be able to interpret and display on the user's video display. After converting the computer file, the client-side list application may display the matching image files in an information bar or inline viewer within the display of the client-side list application. The user may then select a matching image from the inline viewer to add as an icon next to his list entry item. Upon selecting the matching image, the client-side list application may replace the content of its information fields with the corresponding information pertaining to the matching image.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic diagram of a computing system in which the various techniques described herein may be incorporated and practiced.

FIG. 2 illustrates a schematic diagram of a client-side list application display in which the various techniques described herein may be incorporated and practiced.

FIG. 3 illustrates a flow diagram of a method for receiving a list of images files to enhance a list entry item in accordance with one or more implementations of various techniques described herein.

FIG. 4 illustrates flow diagram of a method for sending a packaged file including a list of image files that match the information fields provided by the user in accordance with one or more implementations of various techniques described herein.

### DETAILED DESCRIPTION

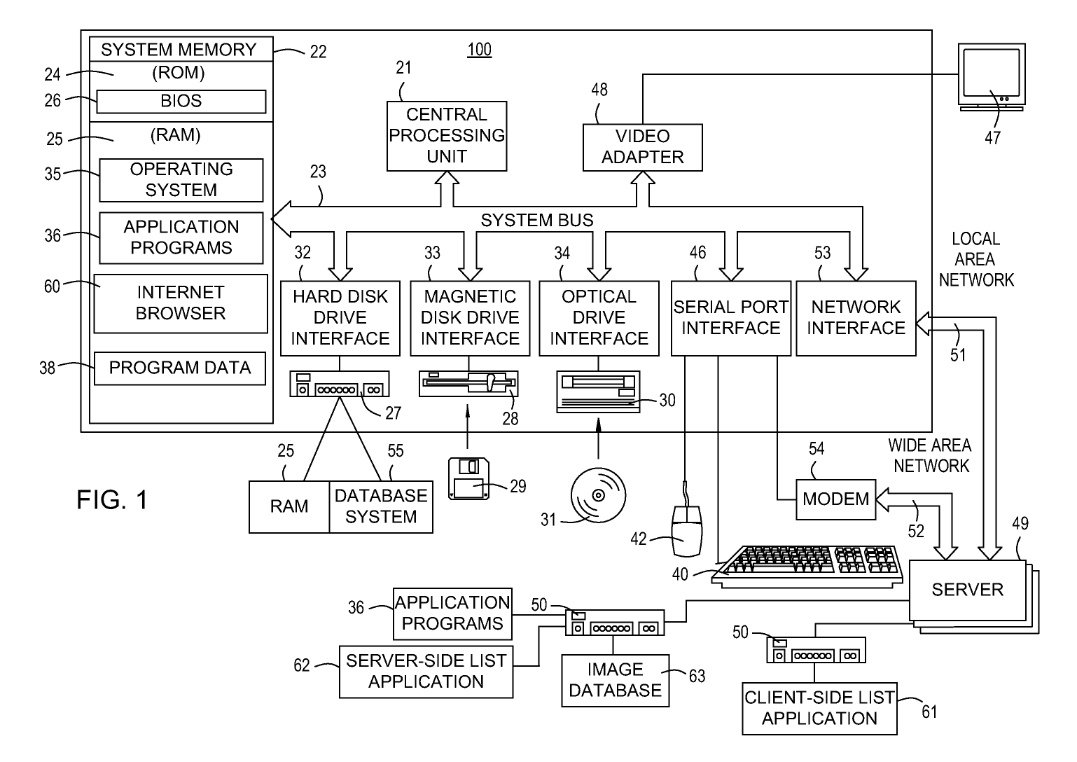

In general, one or more implementations described herein are directed to creating and modifying web-based lists that allow a user to share lists of his favorite movies, books, music, and other interests to an online community. Web-based lists may enable a user to enhance each list entry item by displaying an image next to the list entry item such that the image further describes or illustrates the list entry item. The image displayed next to a list entry may be obtained from a server containing image files stored on its memory. One or more implementations of various techniques for generating and modifying images displayed next to list entries on web-based lists will now be described in more detail with reference to FIGS. 1-4 in the following paragraphs.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that perform particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

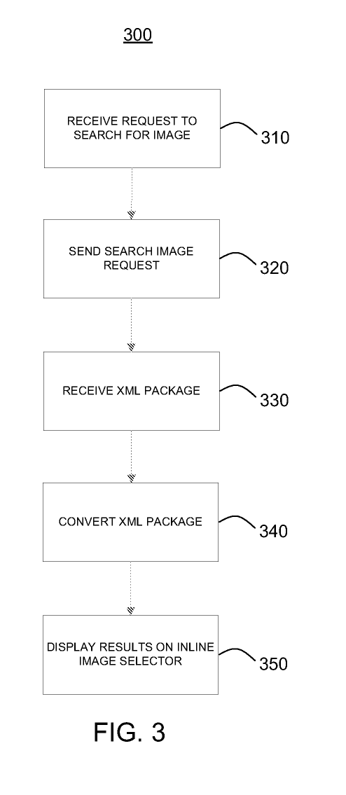

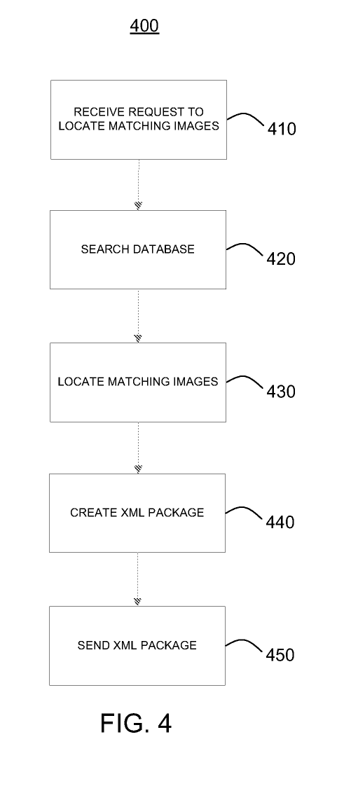

A number of program modules may be stored on the hard disk, magnetic disk 29, optical disk 31, ROM 24 or RAM 25, including an operating system 35, one or more application programs 36, an internet browser 60, program data 38, and a database system 55. The operating system 35 may be any suitable operating system that may control the operation of a networked personal or server computer, such as Windows® XP, Mac OS® X, Unix-variants (e.g., Linux® and BSD®), and the like. The internet browser 60 will be described in more detail with reference to FIGS. 3-4 in the paragraphs below.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices, such as speakers and printers.

Further, the computing system 100 may operate in a networked environment using logical connections to one or more servers, such as a server 49. The server 49 may be another personal computer, a remote computer, a router, a network PC, a peer device or other common network node. Although the server 49 is illustrated as having only a memory storage device 50, the server 49 may include many or all of the elements described above relative to the computing system 100. The memory storage device 50 may also contain a client-side list application 61, a server-side list application 62, and an image database 63. The image database 63 may contain information pertaining to certain images including the Uniform Resource Locator (URL) address of an image and other pertinent information with respect to the image. Although the memory storage device 50 of the server 49 has been described to contain the client-side list application 61, server-side list application 62, and image database 63, it should be noted that in one implementation the client-side list application 61 may be stored on another server separate from the server 49 containing the server-side list application 62 and the image database 63. In one implementation, the client-side list application 61, server-side list application 62, and image database 63 may all be stored on the system memory 22 or the hard drive 32 on the computing system 100. The logical connections may be any connection that is commonplace in offices, enterprise-wide computer networks, intranets, and the Internet, such as local area network (LAN) 51 and a wide area network (WAN) 52. The server 49 may connect to other servers using LAN 51 or WAN 52. The client-side list application 61, server-side list application 62, and image database 63 will be described in more detail with reference to FIGS. 3-4 in the paragraphs below.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

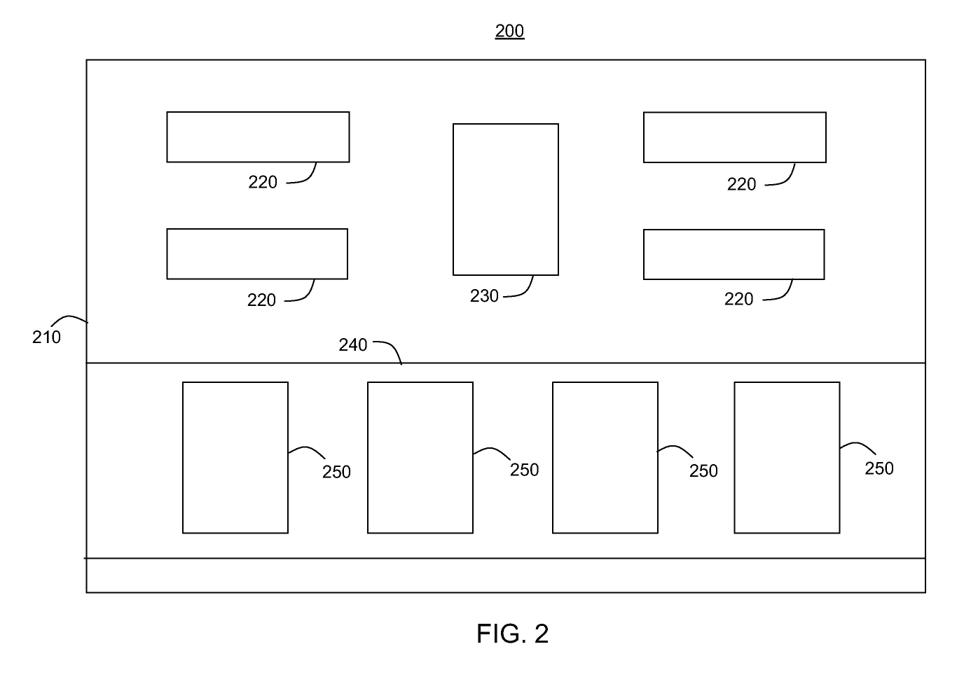

FIG. 2 illustrates a schematic diagram 200 of a client-side list application display 210 in accordance with one or more implementations of various techniques described herein. In one implementation, the client-side list application display 210 may be opened by the internet browser 60, and it may be utilized as a user interface (UI) for the user to add or modify a list entry item to a web-based list. The web-based list may detail the user's favorite movies, books, music, or other genre of interest. The client-side list application display 210 may be displayed on the monitor 47.

The client-side list application display 210 may include information fields 220 to provide specific information pertaining to a list entry item. Each information field 220 may concern a different aspect of the web-based list. For example, if the web-based list pertains to books, the information fields 220 may then request information pertaining to a book's title, author, International Standard Book Number (ISBN), or any other relevant information. Although the information fields 220 have been described with respect to books, it should be noted that the information fields 220 may be altered to pertain specifically to movies, music, or another interest depending on the type of web-list being created or modified.

The client-side list application display 210 may also include a current image 230 that may display the current image associated with the list entry item. In one implementation, if an image has not been associated with the list entry item or the list entry item in newly created, the current image 230 may display a “?”.

The client-side list application display 210 may also include an inline viewer 240 that may display a list of matching images 250 that match terms entered into the information fields 220. Once displayed, the user may then select an image from the list. In one implementation, the inline viewer 240 may not be displayed until a user has submitted a request to locate (or search for) matching images 250. Each matching image 250 may contain information pertaining to the matching image 250 including a specific URL address indicating the location on the server of the actual image file. The matching image 250 may display the image file by connecting to the image file located at the specific URL address. The matching images 250 may also contain additional information pertaining to the displayed image that relate to the data provided in the information fields 220. For example, if one matching image 250 displayed a book cover, the matching image 220 may also contain additional information pertaining to that book such as the book's title, author, ISBN, or any other relevant information.

FIG. 3 illustrates a flow diagram of a method 300 for sending a request to search for images matching the information fields 220 in accordance with one or more implementations of various techniques described herein. In one implementation, the client-side list application 61 may send the request to search for these images and display the results in the inline viewer 240.

As mentioned above, a user may utilize the internet browser 60 to access a social networking website on the Internet. The website may display an option for the user to add a list entry item to a web-based list detailing the user's favorite movies, books, music, or other like interest. After the user selects the option to add the list entry item to a new or pre-existing web-based list, the internet browser 60 may open a client-side list application 61 to receive information pertaining to the list entry item. The internet browser 60 may use a Hyper Text Markup Language (HTML) rendering engine and a JavaScript engine to execute and display the client-side list application 61. The monitor 47 may then display the client-side list application display 210 as described in FIG. 2.

The client-side list application 61 may then wait for the user to input data into the information fields 220 as illustrated in FIG. 2. After adding data to the information fields 220, the user may send a request to the client-side list application 61 to search for an image to be displayed as a thumbnail image next to the list entry item in the web-based list. At step 310, the client-side list application 61 may receive the request to search for an image to add as a thumbnail image next to the list entry item. In one implementation, the user may select an option such as “Search for an Image” on the client-side list application 61; however, the option may also be displayed using another similar phrase or an icon.

At step 320, the client-side list application 61 may use an Asynchronous JavaScript and XML (AJAX) call function to request a server-side list application 62 to locate images that relate to the data contained in the information fields 220. The Ajax call function may enable the client-side list application 61 to invoke the server-side list application 62 in the background of the internet browser 60 without having to refresh or navigate to a different web site on the internet browser 60. The server-side list application 62 may search the image database 63 for images relating to the data contained in the information fields 220. The functions of the server-side list application 62 are described in greater detail in FIG. 4.

At step 330, the client-side list application 61 may receive the image results from the server-side list application 62 in an Extensible Markup Language (XML) package via the AJAX call function. Although it has been described that the client-side list application 61 may receive an XML package, it should be noted that the client-side list application 61 may receive the image search results package in a variety of other forms such as a zip file and the like.

At step 340, the client-side list application 61 may convert the XML package into a JavaScript and HTML source code so that the internet browser 60 may be able to interpret and display the image search results.

At step 350, the client-side list application 61 may display the image search results on the inline viewer 240 located on the UI of the client-side list application 61. The inline viewer 240 may display the image search results as a list of matching images 250 as described in FIG. 2.

In one implementation, the inline viewer 240 may display an enhanced view of a specific matching image 250 when the user rolls the pointing device 42 over the image displayed on the inline viewer 240. The enhanced view may display the matching image 250 in a higher resolution and additional information pertaining to the image. For example, if the inline viewer 240 displays a list matching book images, the enhanced view of one image may display a larger version of the image and additional information about the image such as its title, author, ISBN, and the URL address of the image file. The user may use this additional information to verify that the matching image 250 adequately relates to his list entry item.

Using the inline viewer 240, the user may select the image that he wishes to be associated with the list entry by selecting the specific matching image 250 with the pointing device 42. In one implementation, upon receiving a specific matching image 250 selection, the client-side list application 61 may replace the data that the user originally provided in the information fields 220 with the corresponding data provided with the specific matching image 250. For example, when searching for an image to enhance his list entry item for the books category, the user may only enter data, such as The Cat in the Hat, in the information field 220 pertaining to the title. The matching images 250 may display the book cover image for the book, The Cat in the Hat. If the user selects the book cover image from the inline viewer 240, the client-side list application 61 may replace all of the empty information fields 220 with information obtained from the matching image 250 such as the author, ISBN, the URL address of the book cover image file, and any other relevant information. Further, upon receiving the image selection, the client-side list application 61 may also replace the current image 330 to display the image selection.

FIG. 4 illustrates a flow diagram of a method 400 for the server-side list application 62 to search for images matching the data that the user provided in the information fields 220 and send the resulting images and its relevant information back to the client-side list application 61 in accordance with one or more implementations of various techniques described herein.

At step 410, the server-side list application 62 may receive a request to locate images matching the data provided in the information fields 220 as described in step 320 in FIG. 3. Here, the server-side list application 62 may receive the request from the AJAX call function to use the data contained in the information fields 320 to search the image database 63 for the matching images 250.

At step 420, the server-side list application 62 may search the information fields of each image in the image database 63 for data matching the data contained in the information fields 220.

At step 430, the server-side list application 62 may locate images (matching images 250) that contain data in its information fields that may be similar or identical to the data provided by the user's information fields 220.

At step 440, the server-side list application 62 may combine all of the matching images 250 into an XML package. The XML package may contain the data pertaining to each matching image 250 including the URL address of the actual image file and the corresponding data in the information fields of the matching images 250.

At step 450, the server-side list application 62 may send the XML package to the client-side list application 61 via LAN 51 or WAN 52 using the AJAX call function. Although the matching images 250 have been described as being in an XML package, it should be understood that in some implementations, the server-side list application 62 may package the matching images 250 in another file format such as zip files and the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of searching for one or more images that relate to a list entry item on a web based list, comprising:
receiving a request to search for the one or more images that relate to the list entry;
sending the request to an online server;
receiving a file containing one or more search results having one or more URL addresses indicating one or more locations of the one or more images on the online server and information pertaining to the one or more images; and
displaying the one or more images.

2. The method of claim 1, wherein the request is sent to the online server using an Asynchronous JavaScript and XML (AJAX) call function.

3. The method of claim 1, wherein the file is an XML package.

4. The method of claim 1, further comprising converting the XML package into a source code to facilitate displaying the one or more images.

5. The method of claim 1, wherein the web based list is stored on a social networking website.

6. The method of claim 1, wherein the one or more images are displayed in an inline viewer.

7. The method of claim 1, wherein the file is received using an Asynchronous JavaScript and XML (AJAX) call function.

8. The method of claim 1, further comprising:
receiving information pertaining to the list entry item;
locating the one or more images that substantially match the information; and
creating the file containing the search results.

9. The method of claim 8, wherein the file is an XML package.

10. A user interface for displaying one or more images that relate to a list entry item on a web based list, comprising:
displaying one or more information fields;
receiving input inside the information fields;
receiving a request to search for one or more images that relate to the input;
displaying the one or more images in an inline viewer;
receiving a selection of one of the images to be displayed with the list entry item; and
displaying the selected image adjacent to the list entry item on the web based list.

11. The user interface of claim 10, wherein the input comprises information pertaining to the list entry item.

12. The user interface of claim 10, wherein the list entry item is a book and the input comprises title, author, International Standard Book Number (ISBN) or combinations thereof.

13. The user interface of claim 10, wherein the list entry item is a song and the input comprises name, artist, album or combinations thereof.

14. The user interface of claim 10, further comprising replacing the input with information pertaining to the selected image.

15. The user interface of claim 10, further comprising:
receiving a request to display additional information regarding one of the images in the inline viewer; and
displaying the additional information.

16. The user interface of claim 10, wherein the additional information comprises a higher resolution image.

17. A computer system, comprising:
a processor; and
a memory comprising program instructions executable by the processor to:
receive a request to search for the one or more images that relate to the list entry;
send the request to an online server;
receive an XML package containing one or more search results having one or more URL addresses indicating one or more locations of the one or more images on the online server and information pertaining to the one or more images;
convert the XML package into a source code to facilitate displaying of the one or more images; and
display the one or more images.

18. The computer system of claim 17, wherein the request is sent to the online server using an Asynchronous JavaScript and XML (AJAX) call function.

19. The computer system of claim 17, wherein the one or more images are displayed in an inline viewer.

20. The computer system of claim 17, wherein the XML package is received using an Asynchronous JavaScript and XML (AJAX) call function.
